(19) United States
(12) Patent Application Publication
(10) Pub. No.: US 2012/0197909 A1
(43) Pub. Date: Aug. 2, 2012

(54) METHOD FOR DETERMINING A SIMILARITY OF OBJECTS

(76) Inventors: Jöran Beel, Springe (DE); Béla Gipp, Magdeburg (DE); Jan-Olaf Stiller, Wolfenbuttel (DE)

(21) Appl. No.: 13/444,905

(22) Filed: Apr. 12, 2012

Related U.S. Application Data
(63) Continuation of application No. PCT/DE2009/001421, filed on Oct. 12, 2009.

(51) Int. Cl. G06F 17/30

(52) U.S. Cl. 707/749; 707/E17.012; 707/E17.044

(57) ABSTRACT

A method and a system for determining a similarity of at least two objects referenced by a data tree structure, wherein the method comprising determining the nodes of the at least one data tree structure that reference the at least two objects, determining the distance between two objects referenced by the determined nodes of one data tree structure each, and determining a similarity value for each pair of objects, using the distances determined for the objects of a pair, wherein the system is implemented for performing the method.

### CROSS-REFERENCE TO RELATED APPLICATIONS

This application is a continuation under 35 USC §120 of International Application PCT/DE2009/001421, filed Oct. 12, 2009, the contents of which are incorporated herein by reference.

### FIELD OF THE INVENTION

The invention relates to a method and a system for determining a similarity of at least two objects referenced by at least one data tree structure.

### STATE OF THE ART

Methods are known for determining the similarity of documents, for example. A method known from the state of the art is known as content analysis. In a content analysis, a check is made as to whether two documents contain the same words. The more identical words they contain, the more similar they are. The disadvantage here is that documents can have very similar contents, but the authors can describe the subject with very different words, whether the authors use different languages or different terminology. Similar documents can thus erroneously be classified as not similar. A further significant disadvantage is that so-called full text indexes, which require significant memory space, must be created in order to efficiently analyze the similarity of documents. For a content analysis of other objects, such as music or films, there are indeed methods for determining similarity, but said methods are very imprecise, because it is very difficult to analyze music or especially moving images properly for similarities. Pieces of music are thus often classified manually, because automatic classification is nearly impossible.

A further method known from the state of the art is known as “collaborative filtering.” Here, users evaluate objects on a scale from 1 to 5, for example. The users are then clustered according to their submitted evaluations. If two users A and B evaluate the same objects identically (or similarly), then, for example, those objects that B evaluated positively and with which A is not yet familiar are recommended to user A. The problem here is that a critical mass is often not achieved. Many people do not wish to evaluate objects, and then share said data with third parties. It is further known that objects are classified as similar if, for example, they are often used or purchased together. If, for example, many people buy a camera in an Internet shop and these people also buy a camera bag there, then the camera and the camera bag are classified as similar. A camera bag can then be recommended in the future to a person who buys a camera. The disadvantage here is that fundamentally different objects are classified as similar.

### OBJECT OF THE INVENTION

The object of the present invention is to provide a method and a system by means of which the similarity of objects can be determined particularly reliably and at a high quality level, without having the disadvantages known from the state of the art.

### SOLUTION ACCORDING TO THE INVENTION

This object is achieved by a method having the features of claim 1 and a system having the features of claim 14. Advantageous embodiments of the invention are disclosed in the following description and the further claims.

Accordingly, a method for determining a similarity of at least two objects is provided, wherein the at least two objects are referenced by at least one data tree structure comprising a quantity of nodes connected by links, wherein at least two nodes each represent a reference to one of the at least two objects, wherein the data tree structure can be saved in a memory device, and wherein the method comprises at least the following steps:
determining the nodes of the at least one data tree structure that reference the at least two objects;
determining the distance between two objects referenced by the determined nodes of one data tree structure each, wherein for each two objects, a plurality of distances is determined if at least one of the two objects is referenced by a plurality of nodes of a data tree structure and/or if the two objects are each referenced by nodes of at least two different data tree structures; and
determining a similarity value for each pair of objects, using the distances determined for the objects of a pair.

A data tree structure in which the objects are referenced is used as a data source for determining the similarity of objects. In the following, the term data tree structure or data tree structures is abbreviated as DTS.

According to the invention, data tree structures can be: directory structures (e.g., file systems), Mind Maps, or other hierarchal structures that are suitable for saving references to objects. A data tree structure can also be a computer network, wherein the objects are saved on different computers and wherein the objects have a hierarchal relationship to each other. An electronic file in a directory of a directory structure is designated as an object, for example, or a document that is referenced or linked to from a Mind Map.

Similarity between two objects can also mean: a relationship between two objects or association between two objects. The similarity of two objects is expressed by what is known as the “Tree Proximity Index TPI,” which can have a value between 0 and 1 (0=no similarity, 1=high similarity.) Of course, other value ranges can also be used for the TPI, such as 0% to 100%. The term “similarity value” is abbreviated below as “TPI.” The terms “referencing” and “linking,” as well as the terms “reference” and “link,” are used synonymously below.

A substantial advantage of DTS is that they can be analyzed directly and quickly. For example, it is not necessary to first sell one hundred products in order to reach the necessary critical mass for determining similarity. At the moment that a DTS is created for a user, it can be analyzed immediately. The DTS is also not normally published. That is, it can be assumed that the authors of the DTS are very honest, as a rule, because they create the DTS so that it is best suitable for their purpose. A further advantage is that the similarity between two objects can be determined nearly in real time, which is advantageous particularly when a user moves a document from one directory to another directory, for example which can result in a change to the similarity between the moved object and other objects. A further advantage is that the memory space required for performing an efficient search for similar documents can be significantly reduced, compared to the full text indexes known from the state of the art, because only one single similarity value needs to saved for two documents.

Determining the similarity value can comprise a step for determining a weighting factor by means of which the determined similarity value is adjusted.

A calculated similarity value of two objects can thus be advantageously adjusted, if additional conditions support a higher or lower similarity value.

The similarity values can be saved for each pair of objects in a memory device.

A step for reducing the data tree structure can be performed prior to determining the nodes of the at least one data tree structure. Determining or deriving similarity values between objects can thereby be accelerated, which is advantageous particularly if a very large number of DTS must be analyzed. In addition, reducing can increase the quality of the similarity calculation, because reducing removes nodes that are irrelevant to the similarity calculation.

The data tree structure can be transferred via a communications network from a client device to a server device, wherein the transfer is performed prior to determining the nodes of the data tree structure.

Prior to the transfer, the data tree structure can be converted into a standardized data tree structure format. This allows access to all DTS in the same manner. The standardized data tree structure format can thereby be a data tree structure in XML format.

An object can be at least one of a document, image, music, film, Internet site, and file that can be saved electronically. An object can also, however, be a physical object, such as a book, that is referenced by a DTS using the title, for example.

The invention further relates to, and the aim is further achieved by, a system for determining a similarity of at least two objects, wherein the system is designed for performing the method according to the invention.

### BRIEF DESCRIPTION OF THE DRAWINGS

The invention is further explained using the drawing. The drawing shows:
FIGS. 1 to 3 Examples of data tree structures in non-reduced form and reduced form;
FIG. 4 An example of a data tree structure for explaining the distance calculation; and
FIGS. 5 to 8 Examples of data tree structures for explaining the adjustment of the similarity values using weighting factors.

### DESCRIPTION OF PREFERRED EMBODIMENTS

The method for calculating the similarity value or TPI between two objects can be implemented by a software program that can comprise a client software and a server software, for example.

1. Software Installation and Data Transfer to the Server

A user can install a client software in order to perform the method according to the invention. The software identifies all relevant DTS on the user's computer. A DTS is identified by the file extension, or by the header of files, or in that they are explicitly selected by the user. The software starts either automatically in the background when the computer is booted, by explicitly starting by the user, or by invocation by a third application. The software can search all memory media (hard drive, DVDs, network, etc.), or consider only the main memory, that is, analyze only the DTS that are currently open or otherwise being processed.

The DTS are filtered, if needed, according to factors, such as
size (file size, or quantity of nodes or referenced objects in the DTS)
date of last change or creation
frequency of changes (quantity of changes divided by a time period)
number of links to objects in a DTS (e.g., a Mind Map must contain at least 20 links to websites before it is considered)
memory location (only DTS from particular directories)
DTS type (only mind maps from a particular software, or only the file system, etc.)
Author (only the user's DTS is considered.)

The factors can be arbitrarily adjusted or combined with each other. For example, only those DTS that were created in the last 2 months, contain at least 10 links to objects but have not been changed in the last 3 days, and have been explicitly selected by the user for transfer to the server could be considered. If needed, the DTS are converted into a different format. For example, proprietary Mind Map files could be converted to XML. The DTS are then transmitted to a server, wherein the server software can optionally also run on the user's computer on which the DTS are also located.

2. Saving the Data on the Server

If needed, the DTS are converted into a different format (for example, from a proprietary format to XML.) The server saves the data on the hard drive, in main memory, in a database, or in another suitable medium. The DTS are optionally filtered again according to factors already indicated.

3. Reducing the Data Tree Structure

In some cases, it is advantageous to simplify the DTS before similarity values to the objects referenced in the DTS can be determined Reducing the DTS can occur as follows:
Deleting all end nodes that have no links to objects. FIG. 1 shows a DTS in non-reduced form on the left, and a DTS in reduced form on the right, wherein all end nodes that contain no links to objects have been deleted.
Reducing the link nodes that have no sibling nodes on the nearest level, so that siblings are created. An example of this is shown in FIG. 2.
Merging nodes that link an object without a definitive description. In this case, the link nodes are merged with the parent nodes. A non-definitive description is, for example, when the node name is the same as the file name of the linked object, or is a number. An example of this is shown in FIG. 3.
Filtering according to user criteria or particular texts, such as links labeled in the DTS as “private” or the like being ignored, and/or nodes whose parent node are called “temp,” “todo,” “to be sorted,” “xxx,” etc., are ignored or deleted. The words can be defined by the user or the programmer
Combining the above methods for reducing the DTS.

4. Analyzing the Data Tree Structure

A search is performed in the DTS for those nodes that link to or reference an object. For example, the search looks for hyperlinks, filenames and/or paths, links and/or indirect references to objects, such as BibTeX keys, file numbers, and similar unambiguous keys or document names (or titles.)

After all nodes that link to or reference objects have been found, said objects must be identified in order that it be clear what each is. This can take place in an embodiment as follows:
a. If a hyperlink has been found
   i. the hyperlink itself can serve as the identifier
   ii. for a website (e.g. in HTML or xHTML format), the title can be read from the linked website (for HTML, the text between the tags <title> and </title>.)
   iii. for the case where a file has been linked (PDF, Movie, etc.) the procedure in the next step can be applied.
b. If a file has been linked to, the object type is identified by the file extension or the header of the file. Depending on the type of file, further methods can then be applied. For example
   i. reading the file metadata (title or author, if present), depending on the operating system and file type.
   ii. for a formatted text document (e.g., Word document or PDF): reading the title in that the text having the largest font size on the first page within the first third of the page, and extending for less than four lines, and optionally centered, is determined Said text is then assumed to be the title (numerical values can, of course, be modified arbitrarily here, so that the upper fourth is used instead of the upper third.)
   iii. for a JPEG file: reading the EXIF or IPTC metadata.
   iv. otherwise: generate a hash value (e.g., MD5) or filename and path of the file.
c. If an indirect reference to an object is found, such as a BibTeX key, a search for the BibTeX file is performed on all accessible data media, and the metadata of the object are read there.
d. The data (e.g., title, hash value, etc.) that were determined can be compared to existing data in a database (knowledge base.) For example, if the document title, “The Tree Proximity Index—what is it good for?” has been extracted and if the database already contains an object with the title, “The Tree Proximity Index: what is it good for?” then this is presumably the same object, despite the small difference.

After an object has been identified, its metadata (title, author, URL, Hash.) are saved in a database together with a unique ID, so that the distance values from this object to other objects can be calculated later, and the future identification of the same object that is linked to in a different DTS is made easier.

5. Distance Calculation

After all nodes with links have been identified, the distance between said nodes is calculated. This means that a matrix is created in which the distance from each object to every other object is entered. The distance can be determined in different ways, such as (but not limited to):
a. using all typical methods of graphing, tree, or network theory;
b. or using a visual analysis, in that distance between the linking nodes is measured in cm, mm, etc.;
c. by counting the links between two link nodes.

In FIG. 4, the variant is explained wherein the distance is determined using the nodes. In FIG. 4, the distances are as follows:

Distance (Link1|Link2)=2

Distance (Link1|Link3)=2

Distance (Link1|Link4)=2

Distance (Link1|Link6)=5

The distance values can be saved, or the next step can be applied immediately, in which the similarity values are determined or calculated.

6. Calculating the Similarity Value (TPI)

The TPI of two objects is calculated from the distance of the objects from each other, and is attenuated by certain factors. The basic procedure is as follows:
S1 For each DTS, the TPIs of all potential objects are calculated.
S2 These TPIs are saved.
S3 Different TPIs will now be available for some object pairs.
S4 These different TPIs are then combined in the next step to form an overall TPI.
S5 For an additional or new DTS, the steps S1 and S2 are repeated, and then the overall TPI is calculated again in step S4.

An example is shown below of how a TPI is calculated if two objects are referenced only once within a signal DTS. In this case, the TPI of the two objects is calculated based only on their distance from each other in this single DTS. The TPI of two linked objects can be calculated as

TPI(Obj1|Obj2)=1/(Distance/2)̂2

For the example above of the distances from FIG. 4, the following TPIs would be calculated:

TPI(Link1|Link2)=1/(2/2)̂2=1

TPI(Link1|Link3)=1/(2/2)̂2=1

TPI(Link1|Link4)=1/(4/2)̂2=¼

TPI(Link1|Link6)=1/(5/2)̂2=0.16

Any other arbitrary calculation specifications can be used. The calculated value is a temporary value that can be modified or adjusted by the following factors, wherein the adjustment can be provided optionally:

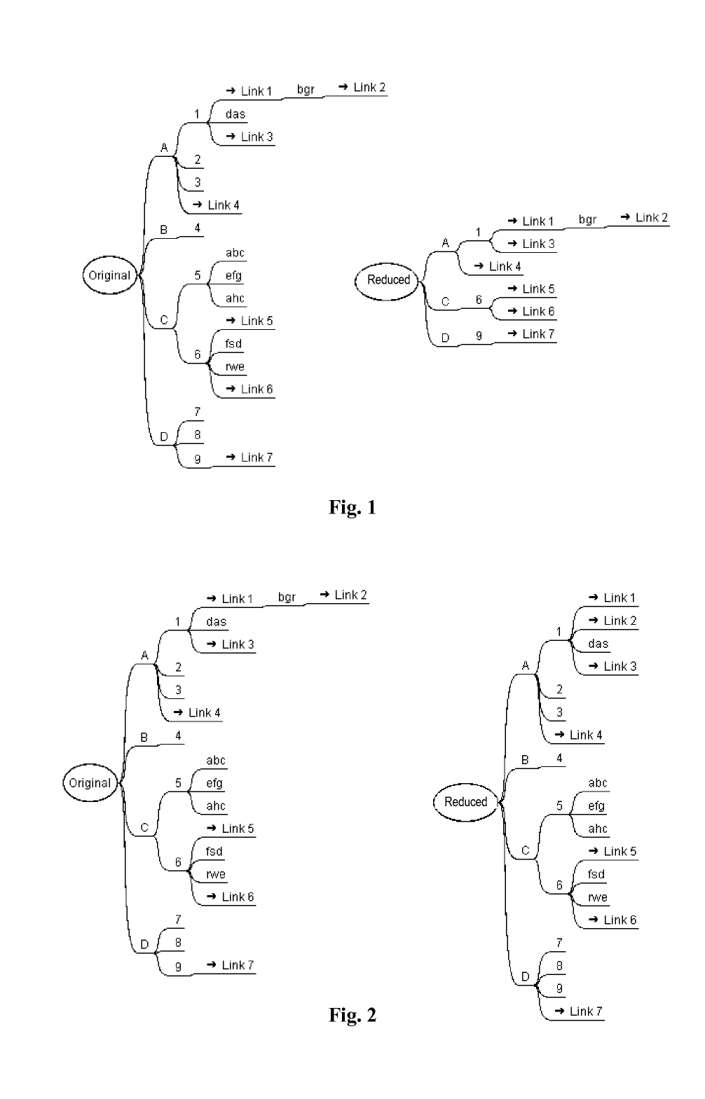

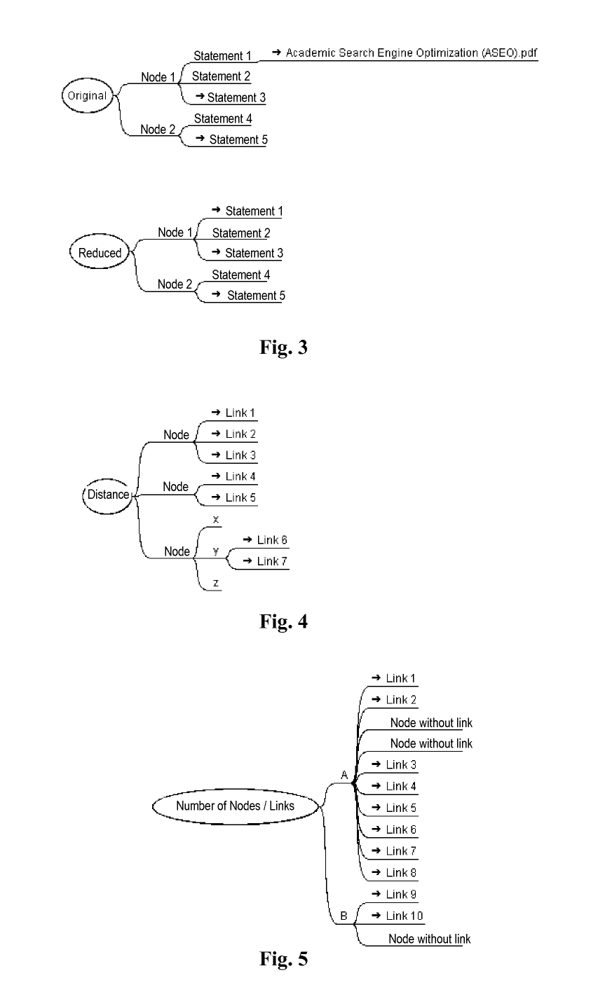

a) Number of Nodes in a Plane
The more nodes (regardless of whether each has a referenced object) are present in a plane, the lower the similarity of the referenced objects. This means that Link1 and Link2, or Link5 and Link6, tend to have lower affinity or similarity to each other than Link9 and Link10. If two links are present in different planes, then all nodes in both planes are summed together. Using the example in FIG. 5, adjustments could be made as follows:
TPInew=TPIold if the quantity of nodes=2
TPInew=TPIold*0.8 if the quantity of nodes is between 3 and 5 inclusive
TPInew=TPIold*0.5 if the quantity of nodes is greater than 5

These calculation instructions are only examples, and can be replaced with other instructions depending on the requirements. Ultimately, it is important that the quantity of the nodes is used as a weighting factor.

b) Depth of the Plane

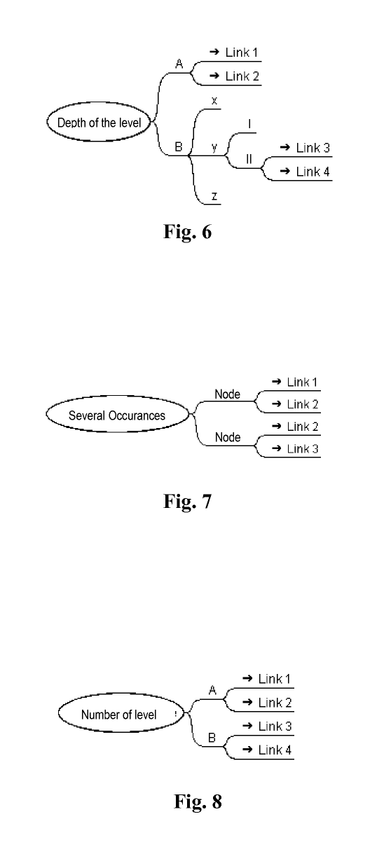

The deeper the plane of two links or two references to objects, the stronger the affinity or similarity between them. In the example from FIG. 6, Link1 and Link2 would tend to be less strongly related or less similar than Link3 and Link4. This is based on the assumption that the deeper the plane, the more specialized the subject.
The new TPI is calculated as the old TPI times the root of the relative depth of the nodes, or

TPInew=TPIold*root(current depth/maximum link depth in the DTS)

In the example from FIG. 6, the depths of Link1 and Link2 are 2 (number of links to the root.) The depths of Link3 and Link4 would be four. That is, the relative depth of Link3 and Link4 is 1( 4/4), the maximum potential depth. The relative depths of Link1 and Link2 is 2/4 or ½. For unequal pairs, such as Link1 and Link3, the lower value is used (thus ½.)

c) Self-Referencing Links
If the user links objects in his DTS that he created himself, or that belong to him, then the similarity values that result can be optionally ignored or attenuated. The same applies for DTS from users that have a close relationship to the producers of linked objects. Users that work for the same organization, for example, or who have worked together on a project, or have published scientific works together, have a relationship. For example: a scientist references himself or a good colleague, with whom he has already published a paper together, in his work. The reference is then ignored.

d) Multiple Linking of an Object in a DTS
It is possible that the same object is linked several times in one DTS (such as Link2 in the example in FIG. 2.) In this case, two different TPIs can be calculated for the pair Link1 and Link2, and for the pair Link2 and Link3. The procedure for calculating the (weighted or adjusted) TPI can be:
i. The TPI is calculated for all potential combinations;
ii. the lower TPI is discarded—only the stronger TPI is used;;
iii. Transitivity: If a TPI X has been calculated for Link1 and Link2, and a TPI Y for Link2 and Link3, it can be assumed that Link1 and Link3 are also similar (transitivity, that is, if A=B and B=C, then A=C, or if A>B and B>C then A>C.) Therefore, according to the invention: If the TPI X has been calculated with a DTS for objects A and B, and TPI Y for objects B and C, then the objects A and C have the TPI X*Y, as long as this value is greater than the directly calculated similarity of A and C. The final value can optionally be limited by one more factor, such as X*Y*0.9.

The TPIs thus adjusted can, in turn, be saved in a data medium.

The example below explains how similarities between objects that are referenced in different DTS are calculated. The basic idea here is that the highest TPI is used. If, however, there are many low TPIs, this can reduce the overall TPI. The overall TPI is then calculated as follows:

Overall TPI=(sum of the highest similarity values+sum(root of the remaining similarity values))/quantity of similarity values

For example: For the pair ObjectX and ObjectY, the five TPIs 0.8; 0.8; 0.5; 0.5; 0.3 have been calculated for five DTS. The overall TPI is thus=(0.8+0.8+root(0.5)+root(0.5)+root(0.3))/5=(0.8+0.8+0.71+0.71+0.54)/5=0.712. If the final value is greater than the greatest individual value (0.8 in the example), then the greatest individual value is used as the overall TPI. As an alternative to said method, the average can also be calculated, only the highest value can be used, etc.

Some objects are referenced very frequently, such as books that are part of the standard literature in a certain area. Here there is very little significance if such a standard work is linked to another book at a short distance. Examples of this are:
The objects A and B have been linked to by three different DTS, and neither A nor B have been linked to in any other DTS.
The objects C and D have been linked to by four different DTS, but object C has been linked to in 10 other DTS as well (which have not linked to object D), and object D has also been linked to in other DTS that have not linked to object C.
A and B are then more strongly related, or more similar, than C and D.

One potential calculation instruction for this would be:

TPInew=TPIold*(quantity of joint references/sum(quantity of individual references))

For example. Objects A and B have been linked together in 3 DTS, and have had a TPI of 0.7. Object A has been linked in 2 additional DTS, and object B in one more. The new TPI is then=0.7*3/(2+3)=0.7*3/5=0.42. Calculations that attenuate the final TPI less severely are also possible.

It can also be assumed that texts will begin with a rather general description, and then become more concrete. Two references or links at the beginning would presumably not be on the same subject, while two links near the end would be closer to the same subject. Therefore, it can be the case that the later two links or references occur, the stronger the relationship between them or the objects that they reference. In the example in FIG. 8, the relationship between Link3 and Link4 would presumably be very slightly stronger than between Link1 and Link2.

In a further embodiment of the invention, the number of edits to a DTS can be considered. This means that the more often a DTS or its entries have been edited, the more reliable the information that can be obtained from it. If, for example, a link or reference to an object is generated, and is edited one week later (for example, moved within the DTS), then it can be assumed that the later classification is of higher quality.

In yet a further embodiment, the competence of the user can be considered. If the creator of a DTS is considered to be particularly competent, then the similarity values calculated on the basis of said DTS are given more weight. Competence can be determined using methods known from the state of the art. If a user is considered by the system to be particularly competent, then the similarity values calculated on the basis of his DTS are given double (or triple) weight when calculating the final TPI. In the above example, in which the similarity values were 0.8; 0.8; 0.5; 0.5; 0.3, and assuming the first value was from a particularly competent user, then the following values would be used as the basis: 0.8; 0.8; 0.8; 0.5; 0.5; 0.3; (that is, one additional 0.8—the first value is considered twice).

In yet a further embodiment, the number of DTS by the same user can be considered. One user could create a great many DTS that all reference the same pair of objects. In this case, the opinion of one user would strongly influence the overall evaluation of the similarity of two objects in an undesired manner. In order to prevent his, the values are considered as an “autonomous system,” so that one total value is calculated from the plurality of values, using the method according to the invention. This total value then flows into the final calculation with the values from other users or other DTS.

An example: We have the values 0.8; 0.8; 0.5; 0.5; 0.3 (cf. above.) One 0.8 and the 0.3 are from the same user. A preliminary similarity value is then calculated from the 0.8 and 0.3: (0.8+root(0.3))/2=(0.8+0.54)/2=0.67.

The final similarity value is then calculated from the 0.67 and the remaining values, namely 0.8; 0.67; 0.5; 0.5. Alternatively, only the highest value or the normal average value of the user can be used.

When calculating similarities between objects that are referenced in different DTS, self-linking can also be considered (see also above.)

For example, the highest TPI can be used and weighted at one-half The other TPIs can be ignored. Using the example 0.8; 0.5; 0.3, and assuming that 0.8 is from the user himself, the TPI would be:

0.5*0.8+root(0.5)+root(0.3)/2.5=(0.4+0.71+0.55)/2.5=0.66

The previously described transitivity can also be considered.

### COMMERCIAL APPLICATION OF THE INVENTION

Using the method and the system according to the invention, recommendation services can be implemented, for example, or search engine results can be improved.

1. Implementation of a Recommendation Service
A user indicates an object that he likes and for which he would like to obtain relevant objects. He can accomplish this, in that he:
i. indicates the name of the object; and/or
ii. indicates a different identifier (e.g. title, author, hash value, etc.); and/or
iii. transfers the object to the server on which the recommendation service is performed; and/or
iv. indicates a URI or the object.

Alternatively, it can be determined automatically which object the user likes. This can be done using typical methods (e.g., implicit and/or explicit evaluations.) A search is then performed for objects from the database that are as similar as possible to the object that the user likes. This search can take place using the similarity values calculated by means of the method according to the invention. The (similar) objects or information about the objects thus obtained are displayed (e.g., on a website or in software.)

2. Improving Search Results Pages

In general, documents that contain a search term are shown on a search results page. The most relevant are shown first. The relevance can be calculated using various methods. It can occur thereby that, in a small list of results, the best matching document A has a very high relevance (e.g., 0.90) and the next best document B has a very low relevance (e.g., 0.40.) The search result is significantly improved in that objects are displayed that are very similar to the relevant documents, but were not considered by the original method (because, for example, the search term does not occur in the document.)

For a document A and a document X, a strong affinity is calculate using the method according to the invention (e.g., 1.) For a text-based search that classifies document A as relevant, document X would also be listed in the results. The relevance for document X for any arbitrary search that considers document A to be relevant is calculated as the relevance of A*similarity of A and X, assuming that both values are between 0 and 1. Otherwise the values would have to be combined in a different manner.

The block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain or store the program for use by or in connection with the instruction execution system, apparatus, or device.

The medium is tangible, and it can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as are suited to the particular use contemplated.

We claim:

1. A computer-implemented method for determining a similarity of at least two objects, wherein the at least two objects are referenced by at least one data tree structure comprising a quantity of nodes, wherein at least two nodes each represent a reference to one of the at least two objects, wherein the data tree structure can be saved in a memory device, comprising:
determining the nodes of the at least one data tree structure that reference the at least two objects;
determining the distance between two objects referenced by the determined nodes of one data tree structure each, wherein for each two objects, a plurality of distances is determined if at least one of the two objects is referenced by a plurality of nodes of a data tree structure and/or if the two objects are each referenced by nodes of at least two different data tree structures; and
determining a similarity value for each pair of objects, using the distances determined for the objects of a pair.

2. The method according to claim 1, wherein the determining of the similarity value comprises a step for determining a weighting factor by means of which the determined similarity value is adjusted.

3. The method according to claim 2, wherein the determining of a weighting factor comprises:
determining for each pair of objects the quantity of links in the data tree structure present in the same plane as the nodes referencing the objects of the pair;
determining for each pair of objects the depth in the data tree structure for each object of the pair;
determining for each object whether the owner of the data tree structure is also the owner of the object;
determining for at least three objects in a data tree structure, wherein one similarity value for a first object of the three objects and one each of the two other objects of the at least three objects can be calculated, a similarity value for the two other objects, using the similarity values between the first object and the other object of the at least three objects in each case (transitivity);
determining for each of two objects referenced from different data tree structures a first quantity of data tree structures jointly referencing the two objects, and determining a second quantity of data tree structures each referencing only one of the two objects, and forming a quotient between the first quantity and the second quantity; and
determining for each pair of objects an absolute position of the objects of the pair within a data tree structure.

4. The method according to claim 1, wherein the similarity values for each pair of objects is saved in a memory device.

5. The method according to claim 1, further comprising reducing the data tree structure prior to determining the nodes of the at least one data tree structure.

6. The method according to claim 5, wherein the reducing comprises:
deleting end nodes that do not represent a reference to an object;
reducing nodes representing a reference to an object on the next higher level of the data tree structure, so that each level of the data tree structure comprises at least two nodes; and
filtering the data tree structure according to previously determined filter criteria.

7. The method according to claim 1, wherein after determining the nodes, identifying the referenced objects is performed, comprising at least:
checking whether the object is a text document; and
reading out the title of the text document, wherein text having a predetermined formatting is detected in the text document.

8. The method according to claim 7, wherein the text having the prescribed formatting is determined in the upper area of the text document.

9. The method according to claim 7, wherein the upper area of the text document is the first third of the first page of the text document.

10. The method according to claim 7, wherein the predetermined formatting comprises:
the largest font size in the text document, and/or the text extends over a maximum of four lines, and/or the text is centered.

11. The method according to claim 1, wherein the data tree structure is transferred via a communications network from a client device to a server device, wherein the transfer is performed prior to determining the nodes of the data tree structure.

12. The method according to claim 11, wherein prior to the transfer, the data tree structure is converted into a standardized data tree structure format.

13. The method according to claim 11, wherein after the transfer, the data tree structure is converted into a standardized data tree structure format.

14. The method according to claim 12, wherein the standardized data tree structure form describes the data tree structure in XML format.

15. The method according to claim 1, wherein the similarity values are saved in a memory device on a server device.

16. The method according to claim 15, wherein the similarity values for each pair of objects are saved in the memory device, such that a quantity of similar objects can be determined for an object, wherein the objects similar to the object are determined using the similarity values.

17. The method according to claim 1, wherein an object is at least one of a document, image, music, film, or web page.

18. A system for determining a similarity of at least two objects, wherein the at least two objects are referenced by at least one data tree structure comprising a quantity of nodes, wherein at least two nodes each represent a reference to one of the at least two objects, comprising a memory device for saving the data tree structure and a processing device coupled to the memory device and designed for performing a method comprising:
determining the nodes of the at least one data tree structure that reference the at least two objects;
determining the distance between two objects referenced by the determined nodes of one data tree structure each, wherein for each two objects, a plurality of distances is determined if at least one of the two objects is referenced by a plurality of nodes of a data tree structure and/or if the two objects are each referenced by nodes of at least two different data tree structures;
determining a similarity value for each pair of objects, using the distances determined for the objects of a pair; and
saving the similarity value in the memory device.

19. A data storage medium product having a program code saved thereon that can be loaded into a computer and/or into a computer network and is designed for performing a method according to claim 1.
